(19) United States
(12) Patent Application Publication
(10) Pub. No.: US 2012/0160113 A1
(43) Pub. Date: Jun. 28, 2012

(54) Sheet Ejecting Apparatus And Stencil Printing Apparatus

(75) Inventor: Daisuke Hasebe, Miyagi (JP)

(73) Assignee: RICOH COMPANY, LIMITED, Tokyo (JP)

(21) Appl. No.: 13/324,020

(22) Filed: Dec. 13, 2011

(30) Foreign Application Priority Data
Dec. 24, 2010 (JP) 2010-287945

(51) Int. Cl. B41L 13/00

(52) U.S. Cl. 101/118

(57) ABSTRACT

A sheet ejecting apparatus includes: first and second sheet discharging members which nip a used stencil base sheet wound on a plate cylinder and which come in press-contact with each other, wherein the first sheet discharging member comes into contact with the used stencil base sheet on the plate cylinder so as to scoop the used stencil base sheet, and the used stencil base sheet is peeled off the outer peripheral surface of the plate cylinder so as to be wound on the second sheet discharging member, and wherein the first sheet discharging member is rotationally driven by a driving unit, and the second sheet discharging member rotates so as to follow the rotation of the first sheet discharging member.

### CROSS-REFERENCE TO RELATED APPLICATIONS

The present application claims priority to and incorporates by reference the entire contents of Japanese Patent Application No. 2010-287945 filed in Japan on Dec. 24, 2010.

### BACKGROUND OF THE INVENTION

1. Field of the Invention

The present invention relates to a stencil printing apparatus which performs a printing operation by winding a stencil base sheet around a plate cylinder, and more particularly, to a sheet ejecting apparatus which discharges a stencil base sheet from a sheet cylinder.

2. Description of the Related Art

Hitherto, there is a known stencil printing apparatus which forms a printing image according to a plate making image on paper by winding a stencil base sheet with perforated holes around the outer peripheral surface of a plate cylinder and transferring ink supplied from the inside of the plate cylinder to the paper through the perforated holes of the stencil base sheet. Here, the stencil base sheet which has been used for the printing operation is held while being wound around the plate cylinder even after the completion of the printing operation in order to prevent occurrence of a failure phenomenon such as degradation of ink or solidification of ink in the openings of the plate cylinder due to the contact of the opening of the plate cylinder to the air. The used stencil base sheet is then peeled off the outer peripheral surface of the plate cylinder with a sheet ejecting apparatus to be discarded before starting a printing operation for the following stencil base sheet.

Various types of sheet ejecting apparatuses which peel the stencil base sheet off the plate cylinder have been proposed. However, in recent years, stencil base sheets of different thicknesses (strengths) or of different types are used to improve the image quality or the like. As a result, there is a problem in that it is difficult to discharge a sheet satisfactorily in particular because a thin stencil base sheet with a low strength becomes wound around a sheet discharging roller of the sheet ejecting apparatus. Further, in the stencil base sheet with a high strength, there are problems in that the stencil base sheet behaves unstably during the sheet discharging operation and the stencil base sheet becomes wound around the sheet discharging roller. Therefore, in order to solve these problems, for example, Japanese Patent Application Laid-open No. 2007-245510 discloses a sheet ejecting apparatus which prevents a stencil base sheet from being wound around a sheet discharging roller.

### SUMMARY OF THE INVENTION

It is an object of the present invention to at least partially solve the problems in the conventional technology.

According to an aspect of the present invention, a sheet ejecting apparatus includes: first and second sheet discharging members which nip a used stencil base sheet wound on a plate cylinder and come into press-contact with each other, wherein the first sheet discharging member comes into contact with the used stencil base sheet on the plate cylinder so as to scoop up the used stencil base sheet, and the used stencil base sheet is peeled off the outer peripheral surface of the plate cylinder so as to be wound on the second sheet discharging member, and wherein the first sheet discharging member is rotationally driven by a driving unit, and the second sheet discharging member rotates so as to follow the rotation of the first sheet discharging member.

According to another aspect of the present invention, a stencil printing apparatus includes the above described sheet ejecting apparatus.

The above and other objects, features, advantages and technical and industrial significance of this invention will be better understood by reading the following detailed description of presently preferred embodiments of the invention, when considered in connection with the accompanying drawings.

However, in the sheet ejecting apparatus disclosed in Japanese Patent Application Laid-open No. 2007-245510, there are problems in that the shape of the sheet discharging roller is complicated, the cost increases, and the rotation speed control of the sheet discharging roller is complicated. Also, in the case of the stencil base sheet having a thin thickness and a low strength, if there is any load applied to the stencil base sheet due to the friction or the like between the stencil base sheet and the sheet discharging roller, the stencil base sheet is damaged and thus the stencil base sheet becomes wound around the sheet discharging roller from the damaged position, which causes a sheet discharging failure.

### BRIEF DESCRIPTION OF THE DRAWINGS

FIG. 1 is a schematic front view illustrating a stencil printing apparatus to which an embodiment of the invention is applicable;

FIG. 2 is a schematic diagram illustrating a first sheet discharging member and a second sheet discharging member which are used in the embodiment of the invention;

FIGS. 3A and 3B are schematic diagrams illustrating a first sheet discharging roller and a second sheet discharging roller which are used in a first embodiment of the invention;

FIG. 4 is a schematic diagram illustrating a first gear, a second gear, and a motor which are used in the first embodiment of the invention;

FIG. 5 is a schematic diagram illustrating a positional relation between the first gear, the second gear, the motor, a plate cylinder, and a sheet discharging box in the first embodiment of the invention;

FIG. 6 is a schematic diagram illustrating a sheet discharging operation in the first embodiment of the invention;

FIG. 7 is a schematic diagram illustrating a second sheet discharging roller and a pin which are used in a third embodiment of the invention;

FIG. 8 is a schematic diagram illustrating a second sheet discharging roller which is used in the third embodiment of the invention;

FIG. 9 is a schematic diagram illustrating a second sheet discharging roller which is used in a fourth embodiment of the invention; and

FIG. 10 is a diagrammatic view illustrating the operation control for an electromagnetic clutch which is used in a fifth embodiment of the invention.

### DETAILED DESCRIPTION OF THE PREFERRED EMBODIMENTS

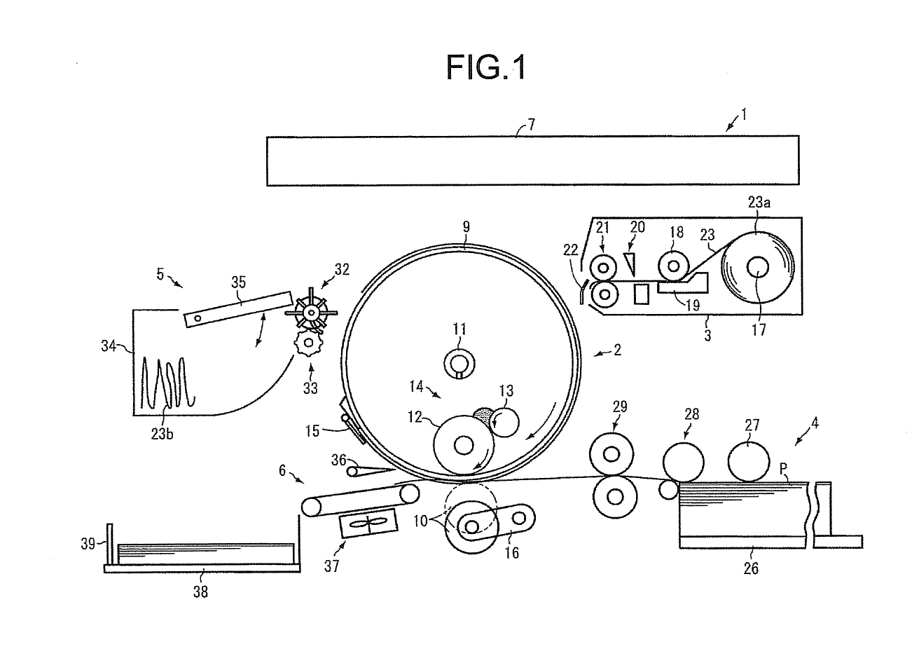

FIG. 1 illustrates a stencil printing apparatus which employs an embodiment of the invention. With reference to FIG. 1, a stencil printing apparatus 1 includes a printing unit 2, a sheet forming unit 3, a paper feeding unit 4, a sheet discharging unit 5 serving as a sheet ejecting apparatus, a paper discharging unit 6, and an image reading unit 7.

The printing unit 2 which is disposed at the approximate center of an apparatus main body (not shown) includes a plate cylinder 9 and a press roller 10. The plate cylinder 9 is rotatably supported by a support shaft 11 which also serves as an ink supply pipe. The plate cylinder 9 is configured to be rotationally driven by a plate cylinder driving unit (not shown) and be attachable to or detachable from the apparatus main body. An ink supply unit 14 which includes an ink roller 12 and a doctor roller 13 is disposed inside the plate cylinder 9. A clamper 15 which holds the front end of the stencil base sheet is attached to the outer peripheral surface of the plate cylinder 9 so as to be able to be open and closed. The outer peripheral surface of the plate cylinder 9 is provided with an opening portion which has a plurality of perforated holes which ooze ink supplied from the ink supply unit 14.

The press roller 10 is rotatably supported by a pair of arm members 16 at both ends of its support shaft. The press roller 10 is disposed below the plate cylinder 9. When each arm member 16 is rocked by a rocking unit (not shown), the press roller 10 selectively occupies a separating position in which the press roller is separated from the outer peripheral surface of the plate cylinder 9 and a press-contacting position in which the press roller is in press-contact with the outer peripheral surface of the plate cylinder 9 with a predetermined press-contact force as shown in FIG. 1.

The sheet forming unit 3 is disposed at the upper right portion of the apparatus main body. The sheet forming unit 3 includes a stencil base sheet holding member 17, a platen roller 18, a thermal head 19, a stencil base sheet cutting unit 20, a pair of stencil base sheet carriage rollers 21, and a guide plate 22.

The stencil base sheet holding member 17 is attached to a side plate (not shown) of the apparatus main body, and the stencil base sheet holding member 17 rotatably, attachably, and detachably holds a core portion of a stencil base sheet roll 23a. In the core portion of the stencil base sheet roll 23a, a stencil base sheet 23 formed by bonding a thermoplastic resin film with a porous carrier is wound in a roll shape.

The platen roller 18 which is disposed at the left side of the stencil base sheet holding member 17 is rotatably supported by a side plate (not shown) of the apparatus main body, and is rotationally driven by a stepping motor (not shown). The thermal head 19 which is positioned below the platen roller 18 includes a plurality of heat generating resistive elements. The thermal head 19 is attached to a side plate (not shown) of the apparatus main body, and the heat generating resistive elements surface thereof is in press-contact with the peripheral surface of the platen roller 18 by a biasing force of a biasing member (not shown). The thermal head 19 selectively makes each of the heat generating resistive elements generate heat while it comes into contact with the surface of the thermoplastic resin film of the stencil base sheet 23, thereby forming thermally melted and perforated sheet in the stencil base sheet 23.

The stencil base sheet cutting unit 20 is disposed at the left side of the platen roller 18 and the thermal head 19. The stencil base sheet cutting unit 20, including a fixed blade which is fixed to a frame (not shown) of the apparatus main body and a movable blade which is movably held with respect to the fixed blade, cuts the stencil base sheet 23 in a manner such that the movable blade rotates or moves up and down with respect to the fixed blade.

The pair of stencil base sheet carriage rollers 21 and the guide plate 22 are disposed at the left side of the stencil base sheet cutting unit 20. The pair of stencil base sheet carriage rollers 21 includes a driving roller and a driven roller which are individually rotatably supported by side plate (not shown) of the apparatus main body 8. The respective driving rollers are rotationally driven in the same direction in synchronization with the platen roller 18 by a driving unit (not shown), and the respective driven rollers come into press-contact with the corresponding driving rollers by a biasing member (not shown). The guide plate 22 is attached to a side plate (not shown) of the apparatus main body, and guides the stencil base sheet which is carried by the platen roller 18 and the pair of stencil base sheet carriage rollers 21 toward the printing unit 2.

The paper feeding unit 4 is disposed below the sheet forming unit 3. The paper feeding unit 4 includes a paper feed tray 26, a paper feeding roller 27, a pair of separating rollers 28, a pair of registration rollers 29, and the like. The paper feed tray 26 capable of stacking multiple sheets of paper P on its top surface is supported by the apparatus main body so as to be movable up and down, and is moved up and down by an elevating unit (not shown). A pair of side fences is disposed on the top surface of the paper feed tray 26, and the respective side fences move in a synchronized manner in the paper width direction which is orthogonal to the paper conveying direction.

The paper feeding roller 27 which has a high-friction resistance member on its surface is disposed at an upper portion of the left end of the paper feed tray 26. The paper feeding roller 27 is rotatably supported by a bracket (not shown) which is supported on the apparatus main body in a manner of being able to rock, and is configured to come into press-contact with the uppermost paper P on the paper feed tray 26 with a predetermined press-contact force when the paper feed tray 26 is moved by an elevating unit (not shown). The paper feeding roller 27 is rotationally driven by a stepping motor (not shown).

The pair of separating rollers 28 is disposed at the left side of the paper feeding roller 27. The pair of separating rollers 28 includes upper and lower rollers each having a high-friction resistance member on its surface, where the upper roller and the paper feeding roller 27 are driven to rotate in the same direction when the paper feeding roller is rotated by the stepping motor (not shown). The lower roller comes into press-contact with the upper roller with a predetermined press-contact force by a biasing force of a biasing member (not shown), and is configured to be rotatable only in the opposite direction to that of the upper roller.

The pair of registration rollers 29 including a driving roller and a driven roller is disposed at the left side of the pair of separating rollers 28. The driving roller is rotatably supported between the side plates (not shown) of the apparatus main body, and is rotationally driven by the stepping motor (not shown). The driven roller is rotatably supported between the side plates (not shown) of the apparatus main body, and comes into press-contact with the driving roller with a predetermined press-contact force by a biasing force of a biasing member (not shown).

The sheet discharging unit 5 is disposed at the left upper side of the printing unit 2. The sheet discharging unit 5 includes a first sheet discharging member 32, a second sheet discharging member 33, a sheet discharging box 34, a compressing plate 35, and the like, and is configured to be attachable to and detachable from the apparatus main body in the form of a unit. Furthermore, the first sheet discharging member 32 and the second sheet discharging member 33 will be described later.

The sheet discharging box 34 which stores used stencil base sheets 23b is configured to be attachable to and detachable from the apparatus main body. The compressing plate 35 press-inserts the used stencil base sheets 23b, which are carried by the first sheet discharging member 32 and the second sheet discharging member 33, into the sheet discharging box 34. The compressing plate 35 is rotatably supported by a unit side sheet (not shown), and is rotated by a rotating unit (not shown).

The paper discharging unit 6 is disposed below the sheet discharging unit 5. The paper discharging unit 6 includes a peeling claw 36, a paper conveying unit 37, and a discharge tray 38.

The base end of the peeling claw 36 is supported on the apparatus main body in a manner of being able to swing. When the peeling claw is swung by a claw swinging unit (not shown), the free end which is formed in an acute shape selectively occupies: a proximity position in which the peeling claw is in close proximity to the outer peripheral surface of the plate cylinder 9 as illustrated in the drawings; or a separating position in which the peeling claw is separated from the outer peripheral surface of the plate cylinder 9 so as to avoid obstacles such as the clamper 15.

The paper conveying unit 37 which is disposed below the peeling claw 36 includes a driving roller, a driven roller, an endless belt, and a suction fan. When the driving roller is driven to rotate by a paper discharging driving unit (not shown) and the suction fan operates, the paper conveying unit conveys the paper P while suctioning the paper on the endless belt.

The paper discharge tray 38 is disposed at the left side of the paper conveying unit 37. The discharge tray 38, which stacks multiple sheets of paper P conveyed by the paper conveying unit 37, includes one end fence 39 and a pair of side fences (not shown) so as to evenly arrange the multiple sheets of paper P stacked on the top surface of the discharge tray 38.

The image reading unit 7 is disposed at the upper portion of the apparatus main body. The image reading unit 7 includes a contact glass on which an original document is placed, a pressure plate which is movable so as to get closer to or get away from the contact glass, a scanning unit which reads the document by scanning a document image, a lens which focuses the scanned image, an image sensor such as a CCD which processes an image that is focused.

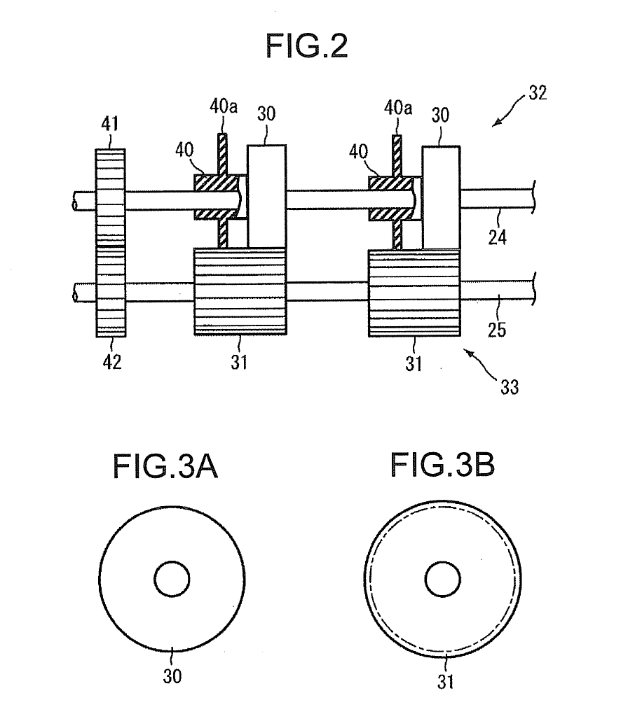

Here, the first sheet discharging member 32 and the second sheet discharging member 33 which are used in the first embodiment will be described. As illustrated in FIG. 2, the first sheet discharging member 32 includes: a first support shaft 24 which is rotatably supported by a bracket (not shown) supported, so as to be able to swing, by a side plate of a sheet discharging unit (not shown); a plurality of first sheet discharging rollers 30 which are fixed to and supported by the first support shaft 24; a plurality of blade rollers 40 which include a blade 40a fixed to and supported by the first support shaft 24; and a first gear 41 which serves as a first transmission unit supported by the first support shaft 24. When the bracket (not shown) is swung by the swinging unit (not shown), the front end of the blade 40a selectively occupies a peeling position in which the front end comes into contact with the stencil base sheet 23 wound on the outer peripheral surface of the plate cylinder 9 and a separating position shown in FIG. 1. The second sheet discharging member 33 includes a second support shaft 25 which is rotatably supported by a side plate of a sheet discharging unit (not shown), second sheet discharging rollers 31 which are fixed to and supported by the second support shaft 25 and which are equal in the number of rollers to the first sheet discharging rollers 30, and a second gear 42 which serves as a second transmission unit supported by the second support shaft 25. The first sheet discharging rollers 30 and the second sheet discharging rollers 31 are configured to come into press-contact with each other even when the first sheet discharging roller 30 occupies any position, and the second gear 42 is configured to mesh with the first gear 41.

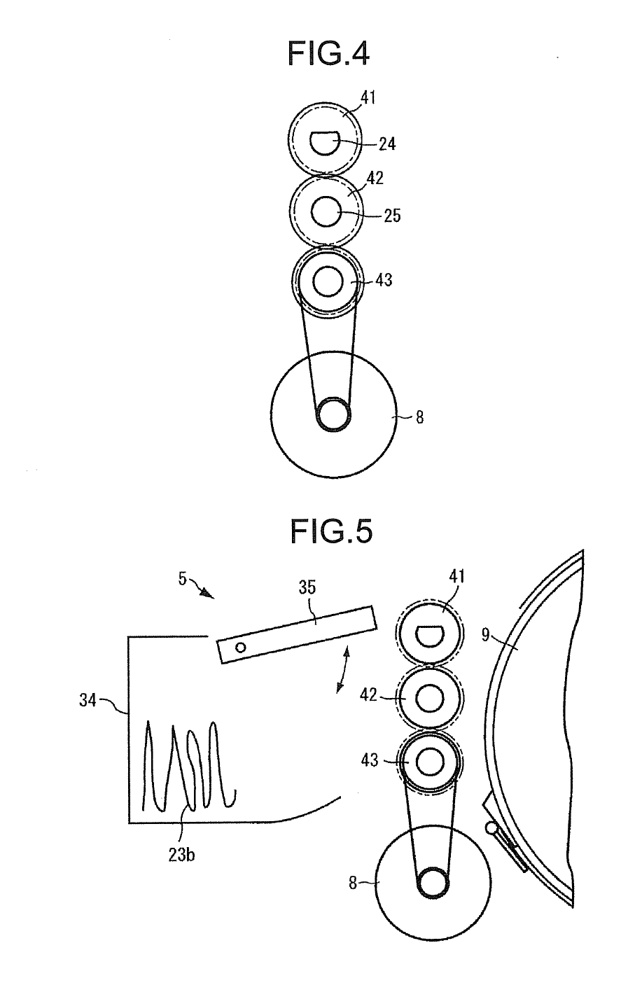

As illustrated in FIG. 3A, the first sheet discharging roller 30 is shaped not to have concavity or convexity on its outer surface, and it is formed of an elastic material such as nitrile rubber. As illustrated in FIG. 3B, the second sheet discharging roller 31 is shaped to have concavity and convexity on its outer surface, and it is formed of a resin such as ABS and polyacetal. As illustrated in FIG. 4, the first gear 41 is fixed to and supported by the first support shaft 24 at a D-shaped hole of the first gear 41, and the first support shaft 24 rotates in accordance with the rotation of the first gear 41. Meanwhile, the second gear 42 is rotatably supported by the second support shaft 25 at an annular hole of the second gear 42, and the rotation of the second gear 42 is not transmitted to the second support shaft 25. A motor 8 as a driving unit which drives the respective gears 41 and 42 to rotate is disposed below the second gear 42. The rotational driving force generated from the motor 8 is transmitted to the second gear 42 via a gear 43, and is transmitted from the second gear 42 to the first gear 41. The first support shaft 24 rotates with the operation of the motor 8. At the same time, the first sheet discharging roller 30 and the blade roller 40 are rotationally driven in the clockwise direction in FIG. 1, and the second sheet discharging roller 31 rotates so as to follow the rotation of the first sheet discharging roller 30 since the rotational force of the motor 8 is not transmitted to the second support shaft 25. FIG. 5 illustrates the positional relation between the respective gears 41, 42, and 43, the plate cylinder 9, and the sheet discharging box 34.

The operation of the stencil printing apparatus 1 will be described below on the basis of the above-described configuration.

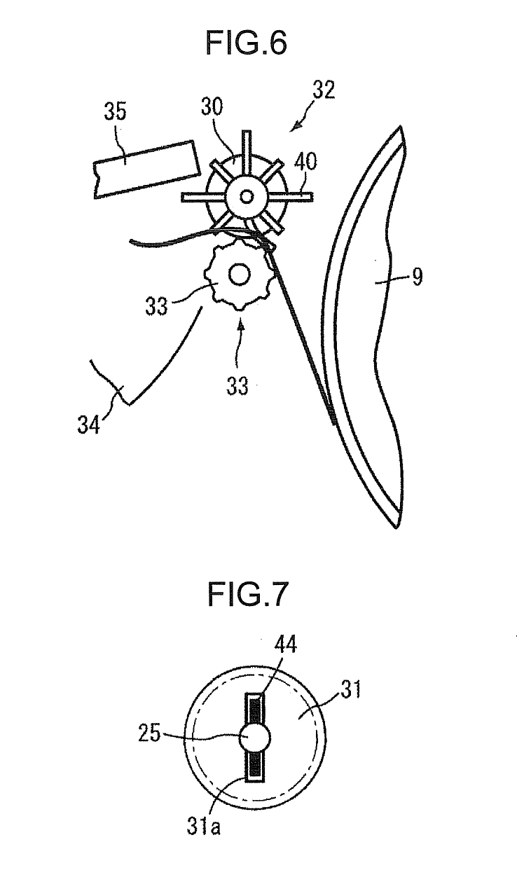

When a document is placed on the contact glass (not shown) and a start key (not shown) is pushed down, the image reading unit 7 reads the document image, and the sheet discharging unit 5 performs a sheet discharging operation of peeling the used stencil base sheet 23b from the outer peripheral surface of the plate cylinder 9. When the start key (not shown) is pushed down, the plate cylinder 9 starts to rotate, and the rotation of the plate cylinder 9 is stopped at the time when the clamper 15 reaches a predetermined sheet discharging position corresponding to the first sheet discharging member 32. Then, as the clamper 15 is released, the first sheet discharging member 32 moves to the peeling position, and the motor 8 is driven so that the used stencil base sheet 23b on the clamper 15 is scooped up by the rotating blade roller 40. Subsequently, the plate cylinder 9 is rotationally driven, the used stencil base sheet 23b on the plate cylinder 9 is nipped and carried so as to be wound around the peripheral surface of the second sheet discharging roller 31 by the first sheet discharging roller 30 which is rotationally driven and the second sheet discharging roller 31 which is rotated in a following manner while coming into press-contact therewith as shown in FIG. 6, and the used stencil base sheet is stored in the sheet discharging box 34. Subsequently, the compressing plate 35 is operated so that the used stencil base sheet inside the sheet discharging box 34 is compressed and the plate cylinder 9 rotates and stops at a predetermined sheet supply position. Then, the stencil printing apparatus 1 is placed in a sheet supply standby state.

When the stencil printing apparatus 1 is in the sheet supply standby state, the platen roller 18 and the pair of stencil base sheet carriage rollers 21 are rotationally driven, so that the stencil base sheet 23 is drawn out from the stencil base sheet roll 23a. The drawn out stencil base sheet 23 is perforated when passing through the thermal head 19, and a sheet forming image is formed on the surface of the thermoplastic resin film. The stencil base sheet 23 is sent to the clamper 15 while a sheet is formed. When the front end of the stencil base sheet 23 is carried based on the number of steps of the stepping motor (not shown) to a position in which the front end thereof may be held by the clamper 15, the clamper 15 closes, and the front end of the stencil base sheet 23 subjected to the sheet forming is held on the outer peripheral surface of the plate cylinder 9.

Subsequently, the plate cylinder 9 is rotationally driven at the same circumferential speed as the carrying speed of the stencil base sheet 23, and the stencil base sheet 23 is wound on the plate cylinder 9. Then, when the sheet is formed in the stencil base sheet 23 corresponding to one sheet, the operations of the platen roller 18 and the pair of stencil base sheet carriage rollers 21 are stopped and the stencil base sheet cutting unit 20 is operated so that the stencil base sheet 23 is cut. The cut stencil base sheet 23 is drawn out from the sheet forming unit 3 with the rotation of the plate cylinder 9, and when the plate cylinder 9 rotates and stops at a home position, the sheet forming operation and the sheet supply operation are completed.

A sheet attaching operation is performed subsequently after the sheet supply operation. When the plate cylinder 9 stops at the home position, the paper feeding unit 4 is operated, so that one sheet of uppermost paper P is drawn out from the paper feed tray 26. Then, the front end of the sheet is nipped between the pair of registration rollers 29 and the plate cylinder 9 is rotationally driven at a low speed in the clockwise direction in FIG. 1. Subsequently, the pair of registration rollers 29 is rotationally driven at a predetermined timing at which the front end of the stencil base sheet 23 wound on the plate cylinder 9 in the image area along the plate cylinder rotation direction reaches a contact position with the press roller 10, and the paper P is fed toward the contact portion between the plate cylinder 9 and the press roller 10. The peripheral surface of the press roller 10 comes into press-contact with the outer peripheral surface of the plate cylinder 9 with the operation of the tilting unit (not shown) at almost the same time of the rotation of the pair of registration rollers 29, and the fed paper P comes into press-contact with the stencil base sheet 23 on the plate cylinder 9. By the pressing operation, the press roller 10, the paper P, the stencil base sheet 23, and the plate cylinder 9 come into press-contact with each other. Then, the ink which is supplied to the inner peripheral surface of the plate cylinder 9 by the ink roller 12 oozes from the perforated hole of the plate cylinder 9, is charged in the porous carrier of the stencil base sheet 23, and is transferred to the paper P through the perforated portion of the stencil base sheet 23, thereby performing so-called mounting.

The paper P to which an image is transferred by the mounting is peeled from the outer peripheral surface of the plate cylinder 9 by the peeling claw 36, is dropped downward to be sent to the paper conveying unit 37, and is suctioned and carried by the paper conveying unit 37 to be discharged onto the discharge tray 38. Subsequently, the plate cylinder 9 rotates and stops again at the home position, the sheet attaching operation is ended, and the stencil printing apparatus 1 is placed in a printing standby state.

After the stencil printing apparatus 1 is placed in the printing standby state, if the start key (not shown) is pushed down after the number of sheets of paper to be printed is registered, the paper P is continuously fed from the paper feeding unit 4 so that the printing operation is performed thereon. Then, when the registered number of sheets of paper to be printed is digested, the plate cylinder 9 stops at the home position and the stencil printing apparatus 1 is placed in the printing standby state again.

According to the above-described configuration, during the sheet discharging operation, only the first sheet discharging roller 30 is rotationally driven and the second sheet discharging roller 31 on which the stencil base sheet 23 is wound rotates so as to follow the rotation of the first sheet discharging roller 30. Accordingly, since a load applied to the stencil base sheet 23 is reduced, it is possible to prevent the stencil base sheet 23 from being damaged and prevent failure during the sheet discharging operation caused by the damage of the stencil base sheet 23.

In the first embodiment, the first gear 41 is fixed to and supported by the first support shaft 24 at the D-shaped hole of the first gear 41; the second gear 42 is rotatably supported by the second support shaft 25 at the annular hole of the second gear 42, and the rollers 30 and 31 are fixed and supported by the support shafts 24 and 25 respectively, so that the second sheet discharging roller 31 rotates so as to follow the rotation of the first sheet discharging roller 30. However, as a second embodiment, a configuration may be adopted in which the first sheet discharging roller 30 is fixed to and supported by the first support shaft 24, the second sheet discharging roller 31 is rotatably supported by the second support shaft 25, and the gears 41 and 42 are fixed to and supported by the support shafts 24 and 25 respectively, so that the second sheet discharging roller 31 rotates so as to follow the rotation of the first sheet discharging roller 30. Even in this configuration, it is possible to obtain the same operational effect as that of the first embodiment.

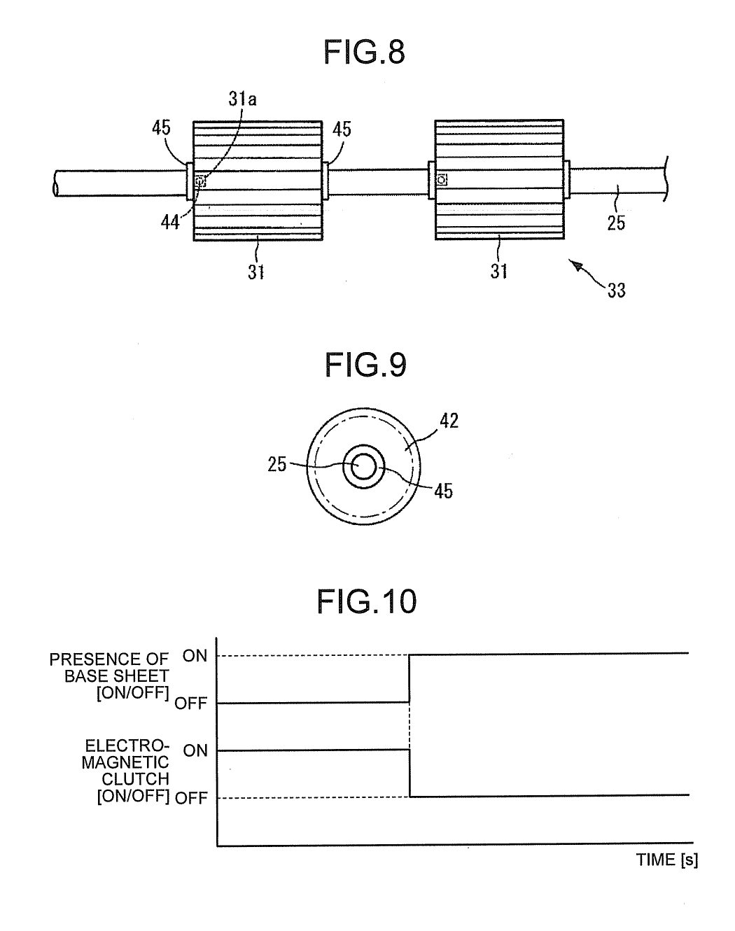

As a third embodiment, in the configuration in which the first sheet discharging roller 30 is fixed to and supported by the first support shaft 24, the second sheet discharging roller 31 is rotatably supported by the second support shaft 25, and the gears 41 and 42 are fixed to and supported by the support shafts 24 and 25 respectively. As illustrated in FIG. 7, the second support shaft 25 may be provided with a hole for allowing a pin 44 to pass therethrough, the end surface of the second sheet discharging roller 31 is provided with a groove portion 31a allowing the pin 44 to be fitted thereto, and an E-ring 45 may be provided to regulate the movement of the second sheet discharging roller 31 in the axial direction as illustrated in FIG. 8. According to the third embodiment, in the case where the pin 44 is not used, it is possible to obtain the same effect as that of the first and second embodiments since the second sheet discharging roller 31 is rotatable with respect to the second support shaft 25. In the case where the pin 44 is used, since the second sheet discharging roller 31 is fixed to and supported by the second support shaft 25, both of the rollers 30 and 31 are rotationally driven satisfactorily when discharging a relatively thicker stencil base sheet or a high-strength stencil base sheet which are unlikely to be damaged, and hence it is possible to perform a satisfactory sheet discharging operation.

As a fourth embodiment, a torque limiter 45 may be interposed between the second gear 42 and the second support shaft 25 in the first embodiment as illustrated in FIG. 9. According to the configuration of the fourth embodiment, when a load which is equal to or larger than a predetermined value is applied to the front end of the used stencil base sheet 23b during the sheet discharging operation, the torque limiter 45 slips, so that the second gear 42 turns idle. Accordingly, it is possible to prevent the used stencil base sheet 23b from being damaged and prevent failure during the sheet discharging operation.

As a fifth embodiment, an electromagnetic clutch may be used instead of the torque limiter 45 used in the fourth embodiment. In this case, when the electromagnetic clutch is turned off at the same time when a base sheet detecting switch (not shown) provided between the sheet discharging members 32 and 33 is turned on (see FIG. 10), the second gear 42 turns idle. Accordingly, it is possible to obtain the same operational effect as that of the fourth embodiment.

According to the invention, during the sheet discharging operation, only the first sheet discharging member is rotationally driven and the second sheet discharging member on which the stencil base sheet is wound rotates so as to follow the rotation of the first sheet discharging member. Accordingly, since a load applied to the stencil base sheet is reduced, it is possible to prevent the stencil base sheet from being damaged and prevent failure from occurring during the sheet discharging operation due to the damage of the stencil base sheet.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sheet ejecting apparatus comprising:
first and second sheet discharging members which nip a used stencil base sheet wound on a plate cylinder and come into press-contact with each other,
wherein the first sheet discharging member comes into contact with the used stencil base sheet on the plate cylinder so as to scoop up the used stencil base sheet, and the used stencil base sheet is peeled off the outer peripheral surface of the plate cylinder so as to be wound on the second sheet discharging member, and
wherein the first sheet discharging member is rotationally driven by a driving unit, and the second sheet discharging member rotates so as to follow the rotation of the first sheet discharging member.

2. The sheet ejecting apparatus according to claim 1,
wherein the first sheet discharging member includes a first support shaft and a first sheet discharging roller which is fixed to and supported by the first support shaft, and the second sheet discharging member includes a second support shaft and a second sheet discharging roller which is fixed to and supported by the second support shaft,
wherein a second transmission unit is supported by the second support shaft so as to transmit a driving force from the driving unit, and a first transmission unit is supported by the first support shaft so as to transmit a driving force from the second transmission unit, and
wherein the first transmission unit is fixed to and supported by the first support shaft, and the second transmission unit is rotatably supported by the second support shaft.

3. The sheet ejecting apparatus according to claim 1,
wherein the first sheet discharging member includes a first support shaft and a first sheet discharging roller which is fixed to and supported by the first support shaft, and the second sheet discharging member includes a second support shaft and a second sheet discharging roller which is fixed to and supported by the second support shaft,
wherein a second transmission unit is fixed to and supported by the second support shaft so as to transmit a driving force from the driving unit, and a first transmission unit is fixed to and supported by the first support shaft so as to transmit a driving force from the second transmission unit, and
wherein the first sheet discharging roller is fixed to and supported by the first support shaft, and the second sheet discharging roller is rotatably supported by the second support shaft.

4. The sheet ejecting apparatus according to claim 1,
wherein the first sheet discharging member includes a first support shaft and a first sheet discharging roller which is fixed to and supported by the first support shaft, and the second sheet discharging member includes a second support shaft and a second sheet discharging roller which is fixed to and, supported by the second support shaft,
wherein a second transmission unit is supported by the second support shaft so as to transmit a driving force from the driving unit, and a first transmission unit is supported by the first support shaft so as to transmit a driving force from the second transmission unit, and
wherein the first transmission unit is fixed to and supported by the first support shaft, and the second transmission unit is supported by the second support shaft through a torque limiter.

5. The sheet ejecting apparatus according to claim 1,
wherein the first sheet discharging member includes a first support shaft and a first sheet discharging roller which is fixed to and supported by the first support shaft, and the second sheet discharging member includes a second support shaft and a second sheet discharging roller which is fixed to and supported by the second support shaft,
wherein a second transmission unit is supported by the second support shaft so as to transmit a driving force from the driving unit, and a first transmission unit is supported by the first support shaft so as to transmit a driving force from the second transmission unit, and
wherein the first transmission unit is fixed to and supported by the first support shaft, and the second transmission unit is supported by the second support shaft through an electromagnetic clutch.

6. A stencil printing apparatus comprising:
the sheet ejecting apparatus according to claim 1.
